(19) United States
(12) Patent Application Publication
(10) Pub. No.: US 2005/0108703 A1
(43) Pub. Date: May 19, 2005

(54) Proactive policy-driven service provisioning framework

(76) Inventor: Charles R. Hellier, (US)

Correspondence Address: HOGAN & HARTSON LLP, ONE TABOR CENTER, SUITE 1500, 1200 SEVENTEEN ST., DENVER, CO, 80202, US

(21) Appl. No.: 10/715,991

(22) Filed: Nov. 18, 2003

(51) Int. Cl. G06F 9/445

(52) U.S. Cl. 717/174

(57) ABSTRACT

A computer network that includes a plurality of compute elements, a repository that includes compute element characteristics for each of the plurality of host computers, and software having at least one operating parameter, where the software is automatically installed on a target compute element selected from the plurality of compute elements, and where the target compute element is selected by comparing the at least one operating parameter with the compute element characteristics. Also, a computer network that includes a plurality of host computers, including a current computer subset and at least one target computer, a repository comprising computer characteristics for each of the plurality of host computers, and software having at least one operating parameter, where the software has been automatically reprovisioned from the current computer subset to the target computer in a reprovisioning event, where the reprovisioning event includes comparing the at least one operating parameter with the computer characteristics or a key performance indicator.

### BACKGROUND OF THE INVENTION

1. Field of the Invention.

The present invention relates to the installation and provisioning of resources in a computer network. More specifically, the present invention includes systems and methods that select hardware resources on a computer network to host software and reprovision software across hardware resources on the network.

2. Relevant Background.

Installing software on a computer network is a manually intensive process. As an initial matter, a network administrator has to manually evaluate the hardware requirements for the software in order to determine which kinds of hardware on the network meet threshold performance criteria to run the software. In addition, software requirements also have to be considered including operating systems and APIs needed to run the software, as well as any programs that need to be present and running. Version requirements for all this software also have to be taken into account.

Beyond threshold hardware and software requirements, the network administrator also has to consider the functions and performance expected of the software on the network. At any given time software is performing numerous operations on the network, including ephemeral tasks taking milliseconds to seconds, longer tasks taking minutes to hours, and tasks carried out by permanent applications taking days, weeks, or months. For all these tasks being performed by the software, the network administrator has to consider the software's priority, availability, reliability, business impact, and security requirements among other factors. Often, minimum performance standards for software operation are spelled out in a service level agreement (SLA) between a network service provider and customer, and the network administrator should insure the software is installed on hardware resources that can meet the SLA requirements.

After all the relevant factors have been considered the network administrator tries to select the most appropriate network hardware to install the software. Given the number and complexity of factors to consider, hardware selection can become an arduous process of capacity planning and predicting for acceptable resource utilization. At worst it could become an intuitive process of trial and error where the software is installed on one piece of hardware after another until all the operating requirements appear to be met. Thus, there remains a need for better systems and methods to install software on a computer network.

Not surprisingly, it is often the case that the first piece of hardware discovered to meet the operating requirements of the software is not the most appropriate hardware on the system. Moreover, even when the most appropriate hardware is selected at the time of installation, the dynamic nature of computer networks can quickly make that selection less than optimal. Thus, the network administrator's work has only begun when software is installed, and a new phase of periodic reprovisioning of network resources should start to ensure the software runs in the most efficient and cost effective manner possible.

Like software installation, conventional reprovisioning of software across network hardware is a manually intensive task for the network administrator. It requires the administrator to compare timely information about the requirements and policies of the software, the capabilities of the network hardware, and the load demand trends on the network. After a complicated analysis, the network administrator rearranges the software on the network's hardware resources in order to maintain or enhance the software's operating efficiency and minimize operating costs.

The more often software is reprovisioned on a network, the greater the percentage of time that the software runs at its peak operating efficiency. However, there is a tradeoff between realizing efficiency gains through reprovisioning and the increased administrative overhead required for more frequent reprovisioning. Viewed from another perspective, reducing the administrative overhead allows more frequent reprovisioning with the same amount of overhead, which in turn means the software operates more efficiently with the same amount of overhead. Thus, there remains a need for increasing the frequency of reprovisioning for the same or less amount of administrative overhead.

### SUMMARY OF THE INVENTION

One embodiment of the invention includes a computer network comprising a plurality of compute elements, a repository comprising compute element characteristics for each of the plurality of compute elements, and software having at least one operating parameter, where the software is automatically installed on a target compute element selected from the plurality of compute elements, and where the target compute element is selected by comparing the at least one operating parameter with the compute element characteristics.

Another embodiment of the invention includes a computer network comprising a plurality of host computers, including a current computer subset and at least one target computer, a repository comprising computer characteristics for each of the plurality of host computers, and software having at least one operating parameter, where the software has been automatically reprovisioned from the current computer subset to the at least one target computer in a reprovisioning event, and where the reprovisioning event includes comparing the at least one operating parameter with the computer characteristics or a key performance indicator.

Still another embodiment of the invention includes a computer network comprising a plurality of host computers, including a first computer and at least one target computer, a repository comprising computer characteristics for each of the plurality of host computers, and software having at least one operating parameter, where the software is automatically installed on the first computer selected from the plurality of host computers, and where the first computer is selected by comparing the at least one operating parameter with the computer characteristics. The software is also automatically reprovisioned from the first computer to the at least one target computer in a reprovisioning event, where the reprovisioning event includes comparing the at least one operating parameter with the computer characteristics or a key performance indicator.

Additional novel features shall be set forth in part in the description that follows, and in part will become apparent to those skilled in the art upon examination of the following specification or may be learned by the practice of the invention. The features and advantages of the invention may be realized and attained by means of the instrumentalities, combinations, and methods particularly pointed out in the appended claims.

### BRIEF DESCRIPTION OF THE PREFERRED EMBODIMENTS

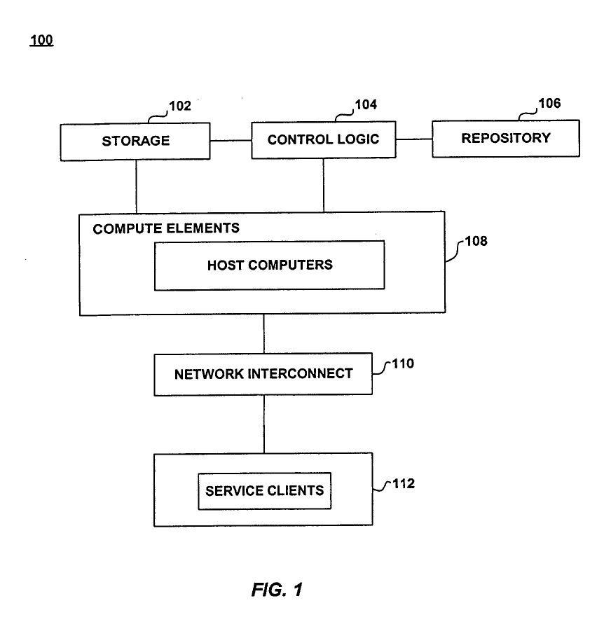

FIG. 1 shows a computer network according to an embodiment of the present invention;

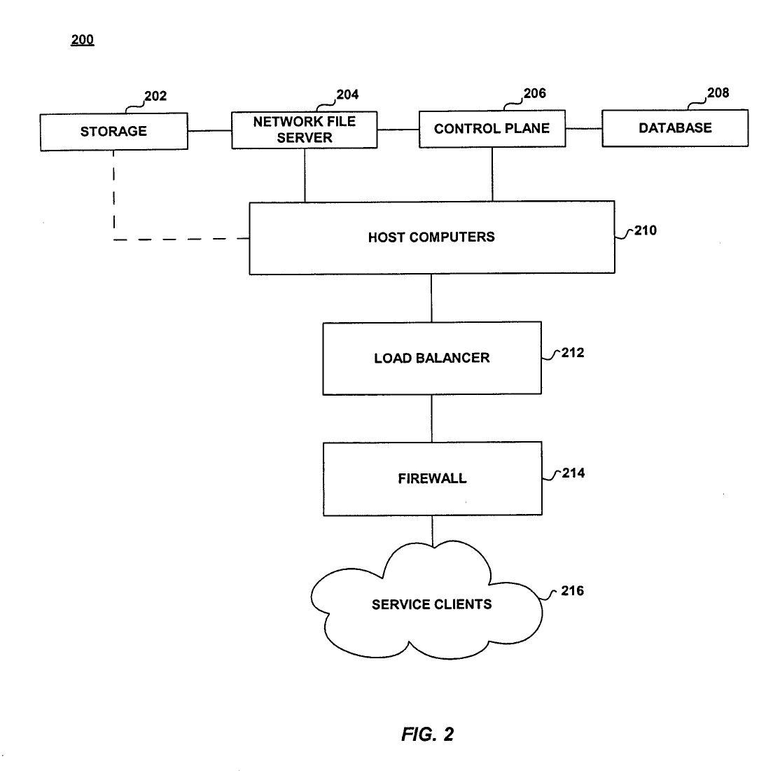

FIG. 2 shows another computer network according to an embodiment of the present invention;

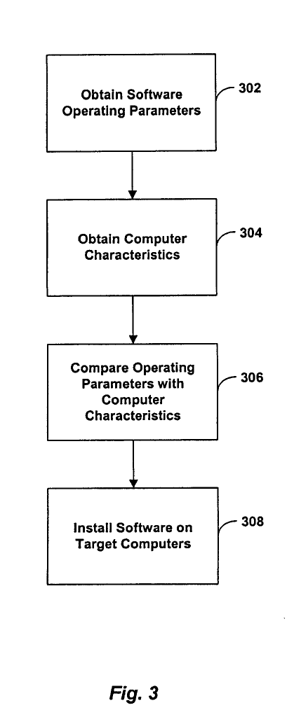

FIG. 3 shows a flowchart of a method of installing software on a computer network according to an embodiment of the invention; and

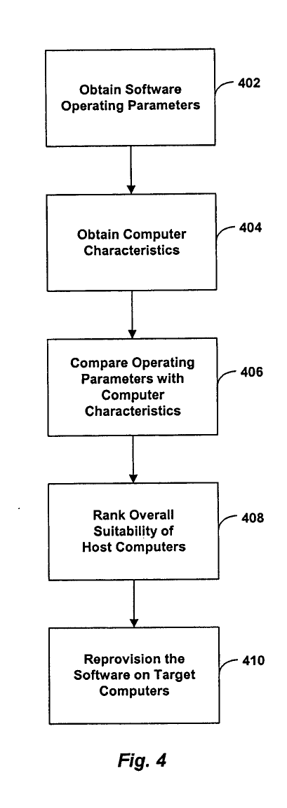

FIG. 4 shows a flowchart of a method of reprovisioning software on a computer network according to an embodiment of the invention.

### DETAILED DESCRIPTION OF THE INVENTION

The present invention includes a computer network where software is automatically installed on a target computer that is selected from a plurality of host computers. Computer characteristics for each of the host computers may be retrieved from a repository and compared with operating parameters of the software to be installed. The comparison may include ranking the suitability of each of the host computers to host the software and selecting the most suitable host computer as the target computer for installation of the software.

After the installation, the computer network may also automatically reprovision the software from one computer (e.g., the original computer upon which the software was installed) to one or more other computers in a reprovisioning event. The software may still remain on the original computer after being reprovisioned. A reprovisioning event may include comparing one or more operating parameters for the software with computer characteristics of the host computers on the network to determine whether there are more suitable host computers to run the software than the current host computer (or computers). If more suitable host computers are discovered, then the reprovisioning event may also include reprovisioning the software from the first computer or computers to one or more target computers identified as more suitable to run the software.

The reprovisioning event may leave the software on the current host computer after it is reprovisioned to the target computers. With the software present on both current host computer and target computers, a network administrator may choose to lower or halt the software's activity on the current host computer and increase the software's activity on the target computers.

A reprovisioning event may also include comparing one or more operating parameters for the software with a key performance indicator. In this aspect, operating parameters for the software may include a minimum level or operating range for a key performance indicator. The key performance indicator may be monitored on the computer network, and if it falls below the minimum level indicated by the operating parameter, then the software may be automatically reprovisioned to new or additional host computers.

The invention includes algorithms that return provisioning and reprovisioning recommendations by determining solutions that address systemic qualities such as availability, reliability, performance, resiliency, usability, extensibility, flexibility, maintainability, portability, reusability and security. For example, an algorithm is contemplated that focuses on reliability and scalability, which makes recommendations, based on populating software instances across as many computers in the network as possible. In another example, an algorithm is contemplated that focuses on cost, which makes recommendations based on minimizing the number of software instances onto the smallest number of computers that can meet service level objectives.

The recommendations put forth by the algorithms may be rationalized by an entity that has decision making authority to execute provisioning events according to prioritization and weighting of variables or key performance objected related to these systemic qualities. The entity could be, for example, a network administrator or intelligence on a control logic host.

The invention will now be described with reference to some examples and embodiments illustrated by the figures. It should be appreciated that the term “software” in the description of the invention is not limited to programs, applications, patches, services (e.g., daemons), and executable code, but may also include other types of computer readable data such as, without being limited to, repository data, text data, string data, array data, and hypertext markup language data among other types of data.

FIG. 1 shows a computer network according to one embodiment of the present invention. The computer network 100 includes compute elements 108, which includes a plurality of host computers. Compute elements 108 are connected to service clients 112 through a network interconnect 110. Compute elements 108 may also be connected to network storage 102 and control logic 104.

In an example, compute elements 108 may be housed separately from service clients 112 such that network 100 is a server farm network. Compute elements 108 may be stateless machines that can be added and removed from a pool of host computers without having to explicitly configure the server. Compute elements may be application servers, database servers, web servers, or storage servers among other types and combinations of servers.

The automatic installation of software on the compute elements 108 may be administered by control logic 104. The control logic may be a service (e.g., a daemon) that sits on a central, high availability configured system. It may be hosted by one or more servers in a high-availability configuration to prevent the termination of all installation, reprovisioning and other activities in the event of a single node failure. Control logic 106 may be a computer containing control logic and may be implemented using application server clustering.

A service may run on each of the compute elements 108 to facilitate communication between control logic 104 and compute elements 108. This service may also provide load information about the software running on each of the compute elements 108 as well as controlling the activity of the software. The service may also synchronize timing between compute elements 108 and control logic 104 by providing telemetry. Synthetic transactions may be performed between control logic 104 and compute elements 108 to verify continued service.

In a software installation, one or more operating parameters associated with the software is compared in control logic 104 with computer characteristics retrieved from a repository 106 for each of the compute elements 108.

Control logic 104 identifies a target computer based on the comparison from among compute elements 108, and installs the software on the target computer. The comparison of the operating parameters with the computer characteristics to identify the target computer may include ranking the overall suitability of each of the compute elements 108 to host the software based on one or more comparisons of operating parameters with computer characteristics. For example, a first comparison may be performed between an operating parameter (e.g., minimum CPU speed) and a relevant computer characteristic (e.g., CPU speed), and each of the compute elements 108 ranked from most to least suitable. A second comparison may also be performed between another operating parameter (e.g., minimum memory) and a relevant computer characteristic (e.g., memory size), and each of the compute elements 108 again ranked from most to least suitable.

After the last comparison is completed, the rankings for each of the comparisons may themselves be compared to determine an overall ranking of the suitability of the compute elements 108 for the software. For example, the ranks of each of the compute elements 108 for each comparison may be assigned a value and the values may be combined to provide an overall suitability value for each of the compute elements 108. The overall suitability values may be ordered to provide a ranking of the overall suitability of each of the compute elements 108 for the software, and the host computer ranked most suitable may be identified as the target computer for software installation.

The automatic reprovisioning of software on the compute elements 108 may also be administered by control logic 104. In one example of a software reprovisioning event, one or more operating parameters of the software is compared in control logic 104 with a key performance indicator. Key performance indicators may relate to measurable aspects of network 100 such as annual downtime for the network, average client response time, and software operating cost rate among other aspects.

When the comparison reveals that the current computer or computers running the software fall below a minimum level set by the operating parameter for the key performance indicator, then control logic 104 reprovisions the software to one or more target computers. For example, if software operating cost rate is the key performance indicator being monitored, when the software operating on the current computer exceeds a certain cost rate, control logic 104 may reprovision the software to a set of target computers where the software operates at a lower cost rate.

Software reprovisioning events may also include comparing one or more operating parameters with the current computer characteristics of each of the compute elements 108. An application server persistence-manager capable database may be used to store a persistent state of computer network 100. When a comparison reveals that one or more target computers are more suitable for running the software than the current computer, control logic 104 reprovisions the software to the target computers.

The comparison of the operating parameters with the computer characteristics to determine if the software is running on the most suitable subset of compute elements 108 (where the subset can range from a single compute element to all of the compute elements) may include ranking the overall suitability subsets of compute elements 108 based on one or more comparisons of operating parameters with computer characteristics. For example, an operating parameter for the software may provide that it is more cost effective for the software to run at higher usage levels on fewer host computers instead of running at lower usage levels on more host computers. A comparison of this operating parameter with the computer characteristics may find a smaller subset of target computers than the current subset to run the software and automatically reprovision the software from the current subset of host computers to the smaller number of target computers. In another example, additional operating parameters (e.g., the availability of the software) are also compared with the computer characteristics and the results of each comparison are weighed to identify the most suitable target computers to reprovision the software.

Operating parameters for the software may be any parameter that describes some aspect of the operation of the software on computer network 100, such as processor (e.g., CPU) requirements, memory requirements, storage requirements, peripheral requirements, networking requirements, operating system requirements, security requirements, timing requirements, software availability requirements, and/or service level agreement (SLA) requirements, among others.

Specifically, processor requirements may include minimum processor speed, processor type, word size (e.g., 32 bit, 64 bit, etc.), cache size, and instruction sets, among other parameters. Memory requirements may include, minimum memory size, minimum memory speed, and memory type (e.g., DRAM, SRAM, SDRAM, etc.) among other parameters. Storage requirements may include minimum storage size, and minimum data retrieval rate among other parameters. Peripheral requirements may include peripheral type, peripheral interface type (e.g., SCSI, USB, PCI, etc.), and minimum peripheral data transfer rate, among other parameters. Networking requirements may include network interface types (e.g., Ethernet, 801.11, etc.), network protocols, and network bandwidth, among other parameters. Operating system requirements may include, operating system type (e.g., Solaris, Linux, Windows), and operating system version, among other parameters. Security requirements may include encryption types, firewall protection, and network accessibility, among other parameters. Timing requirements may include the execution and running time for the software (e.g., milliseconds, seconds, minutes, hours, days, or months). Software availability requirements may include high availability capabilities such as clustering, load balancing, software instance horizontal scalability, and vertical system scalability, among other parameters.

In addition to operating parameters for the hardware, software and security, there may also be operating parameters for service level agreements (SLAs) associated with the software. SLAs include agreements between service providers and customers that specify the level of service a provider has to furnish. Aspects of the service level may be defined using measurable terms (i.e., metrics), which may include percentage of time the software is available, number of clients served simultaneously by the software, frequency of scheduled software maintenance/upgrading, response time, client priority level, and usage level, among other metrics. These metrics may become operating parameters for the software that help select a target computer from among the host computers on the computer network.

SLAs may also incorporate one or more of the metrics into the cost for furnishing the service. For example, a client's cost for network service may be directly proportional to the client's usage level. A client's costs may also increase in exchange for receiving a higher client priority level. Operating parameters for the software may be expressed in terms of costs as well. For example, there may be an operating parameter that sets a maximum cost rate (e.g., dollars/minute) for running the software on the computer network.

Computer characteristics for each of the host computers 110 may be any measure or characteristic of the hardware and/or software associated with the computer such as processor characteristics, memory characteristics, storage characteristics, peripheral characteristics, networking characteristics, operating system characteristics, security characteristics, software availability, and/or service level characteristics, among others.

Specifically, processor characteristics may include minimum processor speed, processor type, word size (e.g., 32 bit, 64 bit, etc.), cache size, and instruction sets, among other characteristics. Memory characteristics may include, minimum memory size, minimum memory speed, and memory type (e.g., DRAM, SRAM, SDRAM, etc.) among other characteristics. Storage characteristics may include minimum storage size, and minimum data retrieval rate among other characteristics. Peripheral characteristics may include peripheral type, peripheral interface type (e.g., SCSI, USB, PCI, etc.), and minimum peripheral data transfer rate, among other characteristics. Networking characteristics may include network interface types (e.g., Ethernet, 801.11, etc.), network protocols, and network bandwidth, among other characteristics. Operating system characteristics may include, operating system type (e.g., Solaris, Linux, Windows), and operating system version, among other characteristics. Security characteristics may include encryption types, firewall protection, and network accessibility, among other characteristics. Software availability requirements may include high availability capabilities such as clustering, load balancing, software instance horizontal scalability, and vertical system scalability, among other parameters.

FIG. 2 shows a computer network according to another embodiment of the present invention. The computer network 200 includes host computers 210 connected to clients 216 through a network interconnect, which in this embodiment is shown as load balancer 212 and firewall 214. The host computers may also be connected to network storage 202 and network file server 204. In another embodiment (not shown) network storage 202 and network file server 204 may be combined into a single storage unit. Each of the host computers 210 may be configured to get its root filesystem from the network attached storage 204, which may be programmed to lock-down host computers 210 whenever possible for added security.

In an example, host computers 210 may worker servers that are housed separately from clients 216 such that network 200 is a server farm network. The compute elements may be stateless machines that can be added and removed from the pool of host computers 210 without having to explicitly configure the server. Compute elements may be application servers, database servers, web servers, or storage servers among other types and combinations of servers.

The automatic installation of software on the host computers 210 may be administered by control plane 206. The control plane 206 may be a service (e.g., a daemon) that sits on a central, high availability configured system. It may be hosted by one or more servers in a high-availability configuration to prevent the termination of all installation, reprovisioning and other activities in the event of a single node failure. Control plane 206 may be a computer containing control logic and may be implemented using application server clustering.

A service may run on each of the host computers 210 to facilitate communication between control plane 206 and host computers 210. This service may also provide load information about the software running on each of the host computers 210 as well as controlling the activity of the software. The service may also synchronize timing between host computers 210 and control plane 206 by providing telemetry. Synthetic transactions may be performed between control plane 206 and host computers 210 to verify continued service.

In a software installation, one or more operating parameters associated with the software is compared in control plane 206 with computer characteristics retrieved from a database 208 for each of the host computers 210.

Control plane 206 identifies a target computer based on the comparison from among host computers 210, and installs the software on the target computer. The comparison of the operating parameters with the computer characteristics to identify the target computer may include ranking the overall suitability of each of the host computers 210 to host the software based on one or more comparisons of operating parameters with computer characteristics.

After the last comparison is completed, the rankings for each of the comparisons may themselves be compared to determine an overall ranking of the suitability of the host computers 210 for the software. For example, the ranks of each of the host computers 210 for each comparison may be assigned a value and the values may be combined to provide an overall suitability value for each of the host computers 210. The overall suitability values may be ordered to provide a ranking of the overall suitability of each of the host computers 210 for the software, and the host computer ranked most suitable may be identified as the target computer for software installation.

The automatic reprovisioning of software on the host computers 210 may also be administered by control plane 206. In one example of a software reprovisioning event, one or more operating parameters of the software is compared in control plane 206 with a key performance indicator. When the comparison reveals that the current computer or computers running the software fall below a minimum level set by the operating parameter for the key performance indicator, then control plane 206 reprovisions the software to one or more target computers.

Software reprovisioning events may also include comparing one or more operating parameters with the current computer characteristics of each of the host computers 210. An application server persistence-manager capable database may be used to store a persistent state of computer network 200. When a comparison reveals that one or more target computers are more suitable for running the software than the current computer, control plane 206 reprovisions the software to the target computers.

Embodiments of the invention also include methods of installing and reprovisioning software on a computer network. FIG. 3 shows a flowchart that includes steps for automatically installing software on a host computer in the computer network.

The installation method starts with obtaining at least one operating parameter associated with the software in step 302. The one or more operating parameters may be included in the machine-readable software data itself, or independently provided to the computer network and associated with the software.

Next, the method continues with obtaining the computer characteristics for each host computer on the computer network in step 304. Each computer characteristic includes data associating the characteristic with a particular host computer. The computer characteristics may be stored and retrieved from a repository (e.g., database) incorporated into or connected with the computer network. As host computers are added, updated and removed from the computer network, the repository may be automatically updated to reflect the current state of the network.

Once the at least one operating parameter for the software and the computer characteristics are obtained, they are compared to determine a target computer for installing the software in step 306. This step may include ranking the overall suitability of each host computer to host the software based on a comparison of the at least one operating parameter with at least one of the computer characteristics for each host computer.

As noted above, an overall suitability ranking may be determined from a comparison of other rankings of the host computers based on their suitability in light of particular operating parameters. In one example, the comparison is a simple addition of the other rankings for each host computer to provide the overall ranking of the host computers. In another example, the comparison first involves weighing the other rankings according to their relative importance the software's operation before adding them up to create the overall ranking of host computers. In still another example, ranking of the overall suitability of the host computers may be based on a single operating parameter.

After the host computers are ranked according to overall suitability for hosting the software, a target computer may be selected and the software automatically installed on the target computer in step 308. Reconfiguration requests may be stored in a queue so that the requests may still reach the host computers in the event of a node failure on the network. An application server may handle fail-over of the message queue.

The selected target computer is normally the host computer ranked as the most suitable for hosting the software. However, there may be situations were a host computer that is not the most suitable is selected as the target computer. For example, the most suitable computer may be scheduled for an upcoming upgrade or removal from the network, making the next most suitable host computer the best target computer for installing the software.

Turning now to FIG. 4, a flowchart is shown that includes steps for automatically reprovisioning software in the computer network according to an embodiment of the invention. The reprovisioning method starts with obtaining at least one operating parameter in step 402 and current computer characteristics in step 404. The at least one operating parameter is compared with the pertinent computer characteristics to determine the suitability of a subset of host computers for running the software in step 406.

The comparison in step 406 may be followed by ranking the overall suitability of the subsets of host computers based on one or more comparisons of operating parameters with computer characteristics in step 408. The software may then be reprovisioned to the subset of host computers ranked most suitable for running the software in step 410.

In another embodiment of a method to automatically reprovision software, a comparison of operating parameters with computer characteristics is stopped once a subset of host computers is discovered that is more suitable to run the software than the current subset. In this approach offers a tradeoff between suitability and reprovisioning overhead: There is a lower probability that the software will be reprovisioned to the most suitable subset of host computers on the computer network, but also less reprovisioning overhead because not every subset has to be ranked during a reprovisioning event.

Embodiments of the methods of installing and reprovisioning the software also include the ability to manually override the selection of a target computer as well as to disable automatic installation. Manual override features may be desirable when significant changes are planned for the computer network that are not reflected in the current set of computer characteristics. For example, a network administrator may want to disable automatic installation of software before a major hardware or operating system upgrade of the computer network.

The automatic installation and reprovisioning methods of the present invention do not have to be the only methods operating on the computer network. For example, the present invention may work with other provisioning systems and methods like resource management methods (e.g., a Fair Share Scheduler) that try to assign the proper amount of processor usage for selected software running on the network. In another example, the present invention may include built-in resource management.

The words “comprise,” “comprising,” “include,” “including,” and “includes” when used in this specification and in the following claims are intended to specify the presence of stated features, integers, components, or steps, but they do not preclude the presence or addition of one or more other features, integers, components, steps, or groups.

1. A computer network comprising:
a plurality of compute elements;
a repository comprising compute element characteristics for each of the plurality of compute elements; and
software having at least one operating parameter, wherein the software is automatically installed on a target compute element selected from the plurality of compute elements, and wherein the target compute element is selected by comparing the at least one operating parameter with the compute element characteristics.

2. The computer network of claim 1, wherein the plurality of compute elements comprises servers.

3. The computer network of claim 2, wherein the plurality of compute elements comprises a server farm.

4. The computer network of claim 1, wherein the compute element characteristics include processor characteristics, memory characteristics, storage characteristics, peripheral characteristics, networking characteristics, operating system characteristics, security characteristics or service level characteristics.

5. The computer network of claim 1, wherein the at least one operating parameter includes processor requirements, memory requirements, storage requirements, peripheral requirements, networking requirements, operating system requirements, security requirements, timing requirements, software availability requirements or service level requirements.

6. The computer network of claim 1, wherein the comparing of the at least one operating parameter with the compute element characteristics comprises ranking the compute element suitability to host the software based on a comparison of the at least one operating parameter with at least one of the compute element characteristics for each of the compute elements.

7. The computer network of claim 1, comprising control logic that receives the at least one operating parameter and the compute element characteristics to perform said comparing of the at least one operating parameter with the compute element characteristics.

8. The computer network of claim 7, wherein said control logic identifies the target compute element to install the software.

9. A computer network comprising:
a plurality of host computers, including a current computer subset and at least one target computer;
a repository comprising computer characteristics for each of the plurality of host computers; and
software having at least one operating parameter, wherein the software has been automatically reprovisioned from the current computer subset to the at least one target computer in a reprovisioning event, wherein the reprovisioning event includes comparing the at least one operating parameter with the computer characteristics or a key performance indicator.

10. The computer network of claim 9, wherein the plurality of host computers comprises servers.

11. The computer network of claim 9, wherein the plurality of host computers comprises a server farm.

12. The computer network of claim 9, wherein the computer characteristics include processor characteristics, memory characteristics, storage characteristics, peripheral characteristics, networking characteristics, operating system characteristics, security characteristics or service level characteristics.

13. The computer network of claim 9, wherein the at least one operating parameter includes processor requirements, memory requirements, storage requirements, peripheral requirements, networking requirements, operating system requirements, security requirements, timing requirements, software availability requirements, or service level requirements.

14. The computer network of claim 9, wherein the key performance indicator includes annual downtime, average response time, or operating cost rate.

15. The computer network of claim 9, wherein the comparing of the at least one operating parameter with the computer characteristics comprises ranking the host computers suitability to host the software based on a comparison of the at least one operating parameter with at least one of the computer characteristics for each of the host computers.

16. The computer network of claim 9, wherein the comparing of the at least one operating parameter with the key performance indicator comprises automatically reprovisioning the software when the key performance indicator falls below a minimum level for the key performance indicator that is set by the operating parameter.

17. The computer network of claim 9, comprising control host logic that receives the at least one operating parameter and the computer characteristics to perform said comparing of the at least one operating parameter with the computer characteristics or the key performance indicator.

18. The computer network of claim 17, wherein said control host logic identifies the target computer to install the software.

19. The computer network of claim 9, wherein said current computer subset comprises one or more of the plurality of host computers.

20. A computer network comprising:
a plurality of host computers, including a first computer and at least one target computer;
a repository comprising computer characteristics for each of the plurality of host computers; and
software having at least one operating parameter,
wherein the software is automatically installed on the first computer selected from the plurality of host computers, and wherein the first computer is selected by comparing the at least one operating parameter with the computer characteristics; and
wherein the software is automatically reprovisioned from the first computer to the at least one target computer in a reprovisioning event, wherein the reprovisioning event includes comparing the at least one operating parameter with the computer characteristics or a key performance indicator.
